(19) United States
(12) Patent Application Publication
(10) Pub. No.: US 2022/0349677 A1
(43) Pub. Date: Nov. 3, 2022

(54) DEVICE FOR LOCATING, SHARING, AND ENGAGING TARGETS WITH FIREARMS

(71) Applicant: P2K Technologies LLC, Orlando, FL (US)

(72) Inventors: Dane Stephens Pigott, Oldsmar, FL (US); Westin Riggs Pigott, Carmel, IN (US); Babak Hossein Karadman, St. Petersburg, FL (US)

(21) Appl. No.: 17/854,972

(22) Filed: Jun. 30, 2022

Related U.S. Application Data
(63) Continuation-in-part of application No. 16/817,166, filed on Mar. 12, 2020, now Pat. No. 11,391,544.
(60) Provisional application No. 62/817,272, filed on Mar. 12, 2019.

(51) Int. Cl. F41G 3/16; F41G 11/00; F41G 3/02; F41G 3/08; G01S 17/08

(52) U.S. Cl. CPC F41G 3/16; F41G 11/001; F41G 3/02; F41G 3/08; G01S 17/08

(57) ABSTRACT

The invention relates to a system to increase the effectiveness of direct fire weapon systems in targeting and destroying a target utilizing the military's existing direct fire weapon systems. The invention consists of a network which communicates with the devices of the invention and that are capable of directing the fire to a specific location.

### CROSS-REFERENCE TO RELATED APPLICATIONS

This application is a Continuation-In-Part Utility patent application claiming priority to U.S. patent application Ser. No. 16/817,166, filed on Mar. 12, 2020, which in turn claims the benefit of U.S. Provisional patent Application Ser. No. 62/817,272, filed Jun. 2, 2021, both of which are incorporated by reference herein in their entirety.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

Trademarks used in the disclosure of the invention, and the applicants, make no claim to any trademarks referenced.

### BACKGROUND OF THE INVENTION

### Field of the Invention

The invention relates to the field of The invention relates to a system to increase the effectiveness of direct fire weapon systems in targeting and destroying a target utilizing the military's existing direct fire weapon systems. The invention consists of a network which communicates with the devices of the invention and that is capable of directing fire to a specific location and target.

### Description of Related Art

It is well understood that a firearm cannot consistently hit a target, even when that target is lined up with the weapon's sighting system, without adjusting for external conditions referred to as ballistics, such as bullet drop, target velocity, range to target, bullet flight time, wind, bullet shape and weight, air pressure, temperature, spindrift, angle to the target (called “cosine angle”), either up or downhill, and others. The ballistics are simpler when the distances are shorter and most shooters who engage in short to regular ranges usually only have to adjust their sights to compensate for gravity but when the range is extended, ballistic factors come into play. These issues are compounded when there is a need to coordinate fire from multiple sources at one or more targets, a problem that is replete in modern warfare. The targets in many situations include more than one target, including targets that are mobile such as unmanned or radio-controlled vehicles that are controlled remotely by an operator using a radio transmitter or other wireless communication technology, and vehicles and other air borne targets such as low flying planes and helicopters. The unmanned or radio-controlled vehicles include devices such as Unmanned Aerial Vehicles (UAS) and small Unmanned Aerial Vehicles (sUAS).

There is a need for a simple system to assist a shooter when engaged in distance shots to calculate ballistics.

When there is more than one shooter there is a need to coordinate the fire from all positions and currently there is not a low-cost and effective system which allows shooters from distal positions to target and coordinate fire on one or more targets.

There is a need for a simple defensive weapon system capable of coordinating fire between multiple weapons and multiple targets that utilizes rifles such as a M16 and M4, and machines guns such as a M249, M240 and M2 which are standard issue weapons and foreign weapons for all U.S. military troops.

### BRIEF SUMMARY OF THE INVENTION

The embodiment in one form is directed to a device and system which consists of multiple electromechanical sensors, information transmission systems, one or more visual displays, and related electronic components. The device is capable of being mounted to a wide variety of weapons systems such as a M16 and M4, and machines guns such as a M249, M240 and M2, and is configured to provide target information to the weapon.

The embodiment's electromechanical sensors are utilized for three purposes: determination of the location of the target or targets, orientation which is the pitch, roll and yaw of the device, and atmospheric conditions such as temperature, pressure and wind velocity and direction.

The embodiment in another form is directed to an effective defense against Unmanned Aerial Vehicles (UAS) and small Unmanned Aerial Vehicles (sUAS) that are designed to utilize current direct fire weapons in the military arsenal rifles such as a M16 and M4, and machines guns such as a M249, M240 and M2.

The invention in another form is directed to a targeting system device that attaches to weapons systems to help direct accurate fire against the UAS and sUAS.

An advantage of the present embodiment is that it utilizes the orientation, location, range to target, and rate of change of the data to accurately locate the target in space and determine its velocity relative to the Earth. This information provides the shooter with the intersection point of target with a predicted trajectory path of the weapon. Also, when two or more separate devices are targeting the same target, the system can utilize their location and orientation data to determine target location and velocity.

These and other objects, features, and advantages of the present invention will become more readily apparent from the attached drawings and the detailed description of the preferred embodiments, which follow.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 shows an embodiment when utilizing two or more Differential Global Navigation Satellite Systems (GNSS) antennas to determine Pitch and Yaw;

FIG. 2 shows an embodiment when using two GNSS antennas and

FIG. 3 shows an embodiment used to determine relative positioning utilizing distance sensors;

FIG. 4 shows an embodiment with regards to components of range;

FIG. 5 shows an embodiment used for intersection targeting using two devices;

FIG. 6 shows an embodiment used for single device targeting;

FIG. 7 shows an embodiment using a mesh network for the communication system;

FIG. 8 shows an embodiment using a mesh network with non-direct connection;

FIG. 9 shows an embodiment using a mesh network with a connection to an external system;

FIG. 10 shows a schematic of an embodiment of the invention showing major components (rear quarter, facing user);

FIG. 11 shows a schematic of an embodiment of the invention showing the front quarter (facing towards target);

FIG. 12 shows an embodiment with a mount for a Picatinny or similar rail system.

FIG. 13 which shows another preferred embodiment that utilizes Artificial Intelligence algorithm of the instant invention.

FIG. 14 which shows a second alternative embodiment utilizing Artificial Intelligence algorithm of the instant invention; and

FIG. 15 which shows a third preferred embodiment utilizing Artificial Intelligence algorithm of the instant invention

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure be considered as an example of the principles of the invention and not intended to limit the invention to the specific embodiments shown and described.

The term user, individual, shooter, war fighter and person as used in this specification are used interchangeably to mean an individual using the system including any sensors, devices, weapons or base station connected to the system of an embodiment of the invention. The term sUAS and UAS as used in this specification are used interchangeably to mean Unmanned Aerial Systems.

The term network as used in this specification includes mesh networks such as Zigbee, Thread, Bluetooth mesh, Z-Wave, Bluetooth networks, WIFI networks and other wired and wireless networks.

The term mesh network as used in this specification means a mesh network (or simply meshnet) and refers to a local network topology in which the infrastructure nodes (i.e. bridges, switches, and other infrastructure devices) connect directly, dynamically, and non-hierarchically to as many other nodes as possible and cooperate with one another to efficiently route data from/to clients.

The term device as used in this specification refers to a device on the network or on a weapon having a networked device. The primary device is the system component that has an onboard computer that communicates with sensors and determines the location, ballistics, orientation, atmospherics, and other conditions and information needed to arrive at an accurate ballistic intercept solution to be displayed for the user to direct their weapon to shoot a target.

The term displayed on a display of the device is used within the specification to also mean automated firing system such as robotics or electrical mechanical weapons firing platform.

The terms device, invention, and system are used interchangeably within the specification to mean an embodiment of the present invention.

A preferred embodiment of the device is a computer system and network which comprises two or more sensor units mounted on firearms or other equipment such as cameras. An on-board computer runs a program to determine target coordinates and provides communication with an optional network. However, higher accuracy is obtained by mounting two sensor units to the same weapon. Therefore, each device is capable of designating targets, engaging targets, or both. When locating a target, the operator of the system visually sights the target. This is accomplished by either an internal optic or camera or by way of an optic, camera, or other weapon sight that is attached to the weapon or device. Once the operator locates the target, they follow it visually. The device uses a laser range finder or other distance measurement sensor to determine the range to the target. The system may also have a camera system with software to help more accurately follow the target. The device uses multiple microelectromechanical sensor systems to accurately determine the device's location and orientation relative to the earth. The device utilizes the orientation, location, range to target, and rate of change of the data to accurately locate the target in space an determine its velocity relative to the earth. Additionally, an embodiment of the device can be configured such that two devices pointing at the same target can utilize their location and orientation data alone to determine target location and velocity, without the aid of distance sensors.

Once a device has the target located and tracked, the device transmits that information to other nearby devices using either an internal radio system or by sending data via wires or wirelessly to an external radio or other data transmission system such that all data is equally shared by all the devices.

When a device receives targeting information, the device can then calculate the most appropriate orientation of the device and attached weapon such as, an M16 and M4, machines guns such as M249, M240 and M2, in order to shoot the target based on the device location and velocity and target location and velocity. This feature is especially useful when the target is a moving object such as an Unmanned Aerial Vehicles (UAS) and small Unmanned Aerial Vehicles (sUAS).

The device may also take into account various ballistic variables such as bullet drop, target velocity, range to target, bullet flight time, wind, bullet shape and weight, air pressure, temperature, spindrift, angle to the target (called “cosine angle”), either up or downhill and others. the specific weapon type, ammunition, gun barrel temperature and other environmental factors which affect the bullet as it flies to the target. Once the device of an embodiment computes the orientation needed, it displays to the operator, via a screen or other interface, such as an automated firing system such as robotics or electrical mechanical weapons firing platform, where to point their weapon and when to shoot in order to hit the target. Alternatively, the device can be used with or without a weapon to direct the operator where to look to see a target which has been located by another device. This is a feature which is useful for those individual war fighters providing forward observer missions.

Specifically, the embodiment is based in part on the realization that a firearm cannot consistently hit a target, even when that target is lined up with the weapon's sighting system, without adjusting for external conditions such as bullet drop, target velocity, range to target, bullet flight time, wind and other factors. Very long shoots such as those performed by snipers will also take into account the rotational effect of the earth known as the Coriolis effect.

Based upon this insight, the device solves the problem of aiming a weapon by a user of an embodiment of the invention and shooting the weapon at the target per the information displayed so that the bullet, when traveling, has an increased chance of hitting the target. This provides the individual or individuals using device an advantage over those individuals not using the invention because a shooter can do everything correctly but if they miscalculate one factor then they increase the probability that they will miss the target. The issues are further amplified when the target is moving.

An embodiment of the invention is a device which consists of an on-board computer processor, multiple sensors, information transmission systems, one or more visual displays and/or automated firing system such as robotics or electrical mechanical weapons firing platform, and related electronic components. The device has a system to allow mounting to a wide variety of weapons systems. The on-board computer processor can be any processor that has the necessary communication and calculation processing capabilities.

The devices of on-board computer processor are equipped with one or more radio systems capable of sending and receiving data.

Data sent by the device's radio systems could include target information (location, velocity, as well as other attributes), device information (location, velocity, system status and other data), information needed for setup and maintenance of the radio network and encryption, as well as video, images, or other data. The use of a network is not mandatory as the device of an embodiment can be used in standalone format whereas the device is paired with its own sensors and weapon.

Data received by the device's radio includes all of the above as well as data which is used by the DGNSS system (called Real Time Correction Measures or RTCM).

The devices may use its internal radio connected to the board computer processor for these data transfers, or alternately could use an external radio connected via wire or wireless link, or a wired link to other devices or external data sources/users.

The devices are designed to communicate with multiple other devices during operation through the on-board computer processor. The invention anticipates a variety of devices such as weapon mounted devices for communication with the shooter, display for communicating with the shooter such as a video display, an indicator light panel, a voice command system or robotic interface or electromechanical firing platform, input devices for use by the shooter to communicate with the on-board computer and other devices on the network, base stations for distributed networking, communication gate ways to other networks, sensor stations for the collection and distribution of sensor data, weapon sensors for collection and distribution to the targeting systems of weapon data such as barrel temperature and other network components. The system sets up and creates a mesh network. A mesh network is a self-reinforcing network with no central hub. Any device in the network can send or receive data from/to any other device at any time. Devices may communicate data point to point (one device sending data to all devices directly) or through repeaters (a device receives data and rebroadcasts it, ensuring a more robust and wide-ranging network).

The device's electromechanical sensors are in communication with the device's on-board computer processor. The electromechanical sensors and computer, which may reside on the network or be indirectly communicating with the device associated with a specific weapon, are utilized for three purposes, to determine the location, orientation, and atmospherics or atmospheric conditions.

With respect to location, this refers to finding the location of the device relative to either the Earth, known points on or above the earth, or to other instances of the same device. These computerized systems are networked, and the device and the on-board computer processor can be utilized individually, or they can be used with more than one device as part of a system. The system can be used to increase accuracy or create redundancies. Specifically, the system can be used with location sensors including Differential Global Navigation Satellite Systems (DGNSS), Ultra-Wide band measurement sensors, Lidar Magnetic, solar, celestial positioning systems and Stadia distance measurement:
a. DGNSS—Differential Global Navigation Satellite Systems. These devices provide locations relative to the Earth (latitude and longitude) that are significantly more accurate than non-differential GNSS (regular GPS). DGNSS systems utilize radio data from satellites as well as correction data from an external source to obtain absolute (in reference to the Earth) accuracies of as small as 1 meter and relative (in reference to the correction data source and to other DGNSS antennas utilizing the same source) of as small as 2 cm.
b. Ultra-Wide band or other distance and speed measurement sensors determine distance and or speed to other devices, targets and other relevant objects, including other out-and-back radio systems, Light Detection and Ranging (LIDAR), ultrasonic, optical systems such as Stadia distance measurement and others. These devices provide distance measurements between the invention and other inventions, and between the invention and external known points. Thus, if there are more than 3 devices (or known points) that can measure from each other, relative (to each other) positions can be obtained for all instances of the invention through triangulation and geometry. If any of the inventions or known points also have an absolute (in reference to the Earth) location known, the absolute location of all the devices near it can be extrapolated.
c. Magnetic, solar, or celestial positioning systems. These systems utilize the Earth's magnetic field, the position of the sun, or the position of stars to inform the absolute (relative to Earth) position.
d. Stadia distance measurement techniques such as those found in rifle scopes.

With respect to orientation to determine the Pitch, Roll and Yaw of the device relative to the Earth and/or other devices the system computers and the device on-board computer processor of the instant invention can be used with Magnetometer, Gyroscope, Accelerometer and DGNSS:
a. Magnetometer, Gyroscope, Accelerometer. These systems, often combined into one system called an inertial measurement unit (IMU) help the device to know its Pitch, Roll and Yaw through direct measurement and algorithmic modeling. These systems can work individually, or more than one system or instance of a system can be used to increase accuracy or create redundancies.
b. DGNSS—Due to high relativistic accuracies (as small as 2 cm), 2 or more DGNSS antennas can be utilized to determine the Pitch, Roll and Yaw of the device through geometry.
c. Distance measurement sensors. Utilizing more than one distance measurement sensor for each device allows the device to determine its orientation (especially Pitch and Yaw) relative to other devices. If another device knows its absolute (relative to the Earth) pitch and yaw, the absolute Pitch and Yaw of both devices can be calculated.

With respect to atmospherics, the system computers and the device on-board computer processor can utilize atmospheric pressure sensors, air temperature sensors, wind speed sensors, wind direction sensors, humidity sensors, and atmospheric haze sensors:
a. air temperature sensor, such as a thermistor, measures the change in electrical resistance in response to changes in temperature; Resistance Temperature Detector (RTD) measures temperature by correlating the resistance of the RTD element with temperature; thermocouple, consists of two wires of different metals connected at two points and the varying voltage between these two points reflects proportional changes in temperature; and semiconductor-based temperature sensor is placed on integrated circuits (ICs). These sensors are effectively two identical diodes with temperature-sensitive voltage vs current characteristics that can be used to monitor changes in temperature.
b. Wind speed and direction sensor such as vane anemometer, thermal anemometer that include constant-temperature anemometer and constant-power anemometer, Light Detection and Ranging (Lidar), and cup anemometers.
c. Wind direction sensor such as wind vane sensors with a potentiometer, vane anemometer, thermal anemometer that include constant-temperature anemometer and constant-power anemometer Light Detection and Ranging (Lidar), and cup anemometers.

Another preferred embodiment utilizes Artificial Intelligence (AI) to identify drones and stabilize the target location. The system uses a sonar device, radar device, CCD camera, infrared sensor device, LIDAR device or similar detection device and acquires or takes an image of the target area.

The AI algorithm is contained in the on-board computer processor is used to identify target objects in the image. These objects which are the targeted by the system can be any object that the algorithm has been trained to identify. Therefore, the target can be an individual, vehicle, drone, communications balloon or parachute or any battlefield device.

The AI algorithm detects where the object is in relation to the frame of the image, which allows the system to know relative location of object in relation to the system.

Once the relative location is known the AI algorithm provides that information to the targeting algorithms to adjust or lock on the target and create a very accurate location data file which is needed to direct the fire at the object.

This helps to eliminate issues with targeting an object where the weapon is not always exactly pointed at the target (i.e., if the target is moving and the individual manning the weapon has trouble following it).

The instant invention using the AI algorithm can be used by a system receiving targets information. The instant invention using the AI algorithm can identify the target and ensure that the system is pointed in the right position. This helps to correct for errors which can occur in the positioning and orientation hardware and allows for targeting to be done under adverse conditions such as if the user position and orientation are experiencing degraded conditions such as when the system GPS is jammed, or you are indoors and not able to receive GPS information.

Additionally, the AI algorithm targeting data can be sent between two or more systems to help the users pick out the correct target. This is important where the target is located in a group. For example, if there are two individuals next to each other, one wearing red and one wearing blue, and the blue individual is targeted, the receiving systems will show the user to engage the “blue individual.” This helps ensure the user has accurate target information before engaging but also to be able to pass that information along to other individuals and weapons.

Using the AI algorithm and statistical modeling the instant invention can “fill in the gaps” on when tracking a moving target and one or more readings are not aligned. The AI algorithm will fit the received data into a model and calculate the track or position of the target.

Furthermore, the instant invention system is designed to be able to track moving objects, but by the nature of warfare and the system, there can be times where data from certain sensors is not available or is showing incorrect data. The AI algorithm will fit the received data into a model and calculate the track or position of the target thereby providing predictive information to the user.

The system can use the AI algorithm to compensate and create the most likely target track even with one or more degraded sensors. This minimizes the time to remove the target from the battlefield and reduces the danger to all friendly combatants.

A second alternative embodiment utilizing the AI algorithm of the instant invention uses the AI algorithm to automatically identify potential targets and classify them. This is similar to the previously described AI system. The AI algorithm in this embodiment takes or acquires an image and labels and geo-locates all potential targets within the image.

The data is then displayed to the user which provides them with various target information. This target information is used to create targets which can be fired upon. An example is that the user can issue a command to the system to target all tanks that are in view, and the AI algorithm will create a target package finds all the tanks and provide target information. The instant invention can also send to other users or area commanders the information for intelligence and targeting purposes.

The instant invention can also utilize visual and/or lidar devices connected to the system as additional source of information for orientation and positioning of targets. This is particularly useful when the system GPS is degraded, jammed, or denied in the specific environment. Alternative image devices include sonar device, radar device, CCD camera, infrared sensor device and LIDAR device.

The third preferred embodiment utilizing Artificial Intelligence of the instant invention is similar in concept to the second preferred embodiment except it uses the AI algorithm to understand the system's location and orientation, not the target's location.

The instant invention can use the AI algorithm to proactively detect shooter peculiarities and adjust the ballistic solution to accommodate them.

The AI can learn individual shooter needs and adjust accordingly.

### Examples

a. Shooter consistently pulls left. The AI algorithm can adjust the solution to compensate for it.
b. Shooter is slower or faster on trigger pull than standard. The AI algorithm can adjust the shots.

The AI algorithm can also adjust for users based on differences in the environment and conditions such as hot weather or after a long run the shooter will be faster/slower than normal.

This system can find cause/effects which may not be obvious to a human observer and implement changes based off the issues identified. For example, the AI algorithm can adjust if a soldier is slower to shoot when its cloudy. We may not know why, but it can still be compensated for.

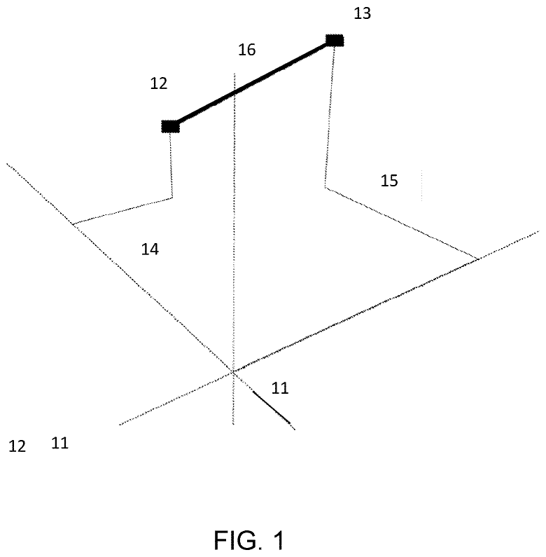

Referring now to the drawings, and more particularly to FIG. 1, there is shown an embodiment comprising of the system computers and the device on-board computer processor of the instant invention. When in use, the system utilizes two or more differential Global Navigation Satellite Systems (GNSS) antennas. When utilizing two or more GNSS antennas, the antennas are mounted to separate areas of the weapon (preferably in line with the barrel and as far apart as possible). The further the devices are from each other, the more accurate the readings will be since the small inaccuracies of the antennas will become smaller in relation to the distance apart.

Therefore, from FIG. 1 when the device uses two or more DGNSS antennas to determine Pitch and Yaw in communication with the system computers and/or the device on-board computer processor of the instant invention, the dashed lines are the XYZ coordinate plane.

DGNSS antenna 11—there are two antennas 11

DGNSS antenna 12—there are two antenna 12

A device uses the DGNSS X, Y and Z components of the location of antenna 11

A device uses the DGNSS X, Y and Z components of the location of antenna 12

A device using the system computers and the device on-board computer processor of the instant invention to calculate the line connecting DGNSS antenna 11 and 12 which is item 16 which is determined from trigonometry utilizing the XYZ components of DGNSS antenna 11 and 12. The line is along the Pitch and Yaw of the device. Therefore, when utilizing two or more GNSS antennas, the antennas are mounted to separate areas of the weapon (preferably in line with the barrel and as far apart as possible). The further the devices are from each other, the more accurate the readings will be since the small inaccuracies of the antennas will become smaller in relation to the distance apart.

An advantage of the device of the invention is that it can use more than one distance measurement sensors. Utilizing more than one distance measurement sensor for each device allows the device to determine its orientation (especially Pitch and Yaw) relative to other devices. If another device knows it's absolute (relative to the Earth) pitch and yaw, the absolute Pitch and Yaw of both devices can be calculated.

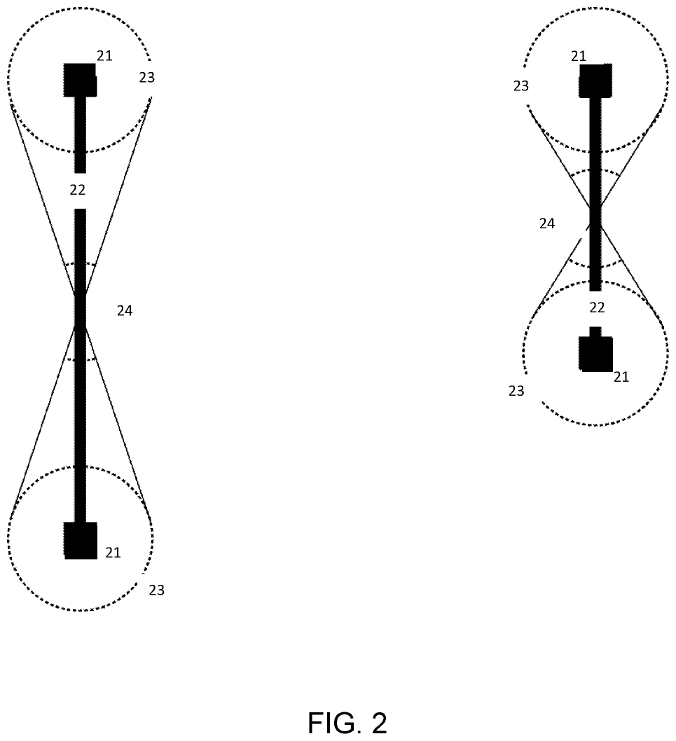

Referring now to FIG. 2, which shows an embodiment of the invention using two GNSS antennas attached to a single weapon and device of an embodiment and which results in decrease in expected inaccuracies of orientation by increasing the distance between GNSS antennas. FIG. 2 showing the decrease in expected inaccuracies of orientation by increasing the distance between GNSS antennas 21.

The fixed mounting position when GNSS antennas 21 are mounted on a weapon and attached to the device on-board computer processor of the instant invention is shown by line 22. The position error window is shown as the circle 23 and the orientation error probability is shown as angle 24. A smaller angle shows led error probability, shown by the dotted line.

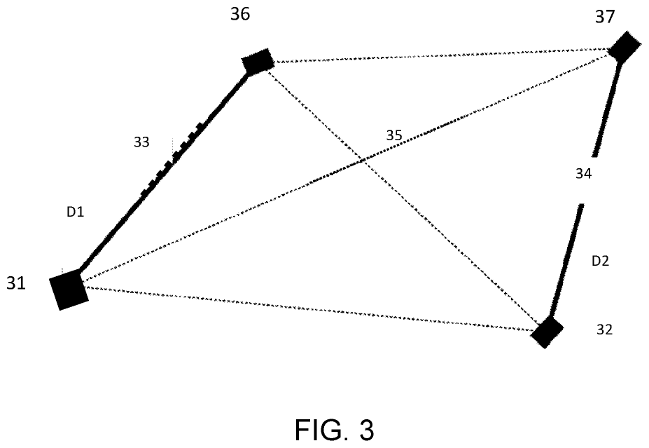

Referring now to FIG. 3, which shows an embodiment of the invention used to determine the relative positioning utilizing distance sensors in communication with the device on-board computer processor of the instant invention. Each device has two distance sensors mounted on it: device 1 (D1) has sensors 31 and 36, and device 2 (D2) has sensors 32 and 37. The black line 33 and 34 are known distances, since the sensors are fixed to the same weapon or piece of equipment. The sensors measure the distance to other sensors (dotted lines), which make the trigonometric shapes. There is no target in this instance, these sensors only determine orientation between two devices. Later, by knowing the relative orientation of both devices, and the relative location of a target to either device, the relative location of the target compared to the other device is calculated. Therefore, determining relative positioning utilizing distance sensors

Distance sensors on device 1 D1 are 31 and 36.

Distance sensors on device 2 D2 are 32 and 37.

Since the sensors are in a fixed position on device 1 (D1), the length of this line is known, line 33.

Since the sensors are in a fixed position on device 2 (D2), the length of this line is known line 34.

These (dashed) lines are determined by the distance sensors. Utilizing trigonometry, the resultant angles and sides give relative location and orientation of the devices.

As noted, earlier atmospherics conditions are external variables that effect the flight path of a bullet and must be compensated for in order to achieve the most accurate ballistic intercept solution. The computer program of the device of the invention in an embodiment collects these atmospheric conditions and applies them to the coordinate calculations to arrive at a target position.

Temperature. Temperature effects the speed of the bullet through air as well as the burn of the gunpowder propelling it. A thermometer can be included to compensate for temperature.

Barometric pressure. The barometric pressure of the air will slow a bullet down to varying rates. This can be measured and compensated for by a barometer.

Wind speed and direction can both slow a bullet down and cause it to change directions. The wind speed and direction can be compensated for by an anemometer.

Temperature, pressure and wind can be directly calculated by sensors in the device, calculated from external sensors paired with the device, or, data on temperature, pressure and wind can be transmitted from external sources (such as military weather teams) to the devices.

Target velocity and direction can also be integrated into calculations to determine the firing target location of a moving target.

These conditions are collected from the various sensors on the device or present on the network, so they can be factored into the solution.

Once a target is sighted in by the operator, the operator will trigger the device to mark the target location. The target location can be marked either for one specific time (i.e. the target is marked once when the operator triggers the device), multiple times, or for a continuous period (the device continues to update the target location as long as the operator triggers it and follows the target).

Triggering the device to mark the target will cause the device to utilize the data it receives from its sensors to determine the target location either absolutely (relative to the earth) or relatively (relative to the device). The device is capable of marking the target by itself when utilizing the devices distance sensors and other sensors. Alternatively, two or more devices can be used to mark a target without the aid of the distance sensors, or to create a more accurate target location.

Utilizing either method, the devices rely on triangulation to find the target location. In trigonometry and geometry, triangulation is the process of determining the location of a point by forming triangles to it from known points. Triangles are made up of 3 sides and 3 angles. Knowing at least 3 of these 6 items (as long as at least 1 is a side) allows the other sides and angles to be known.

The target location can then be broken down into X, Y, and Z components (cartesian coordinates) using the trigonometric Law of Sines. Alternately, the location can be determined as a distance and vector, or other mathematical concepts for showing the location of an object in space. The solution is calculated and fed into the firing display for the shooter to use. The coordinates returned are based on the weapon's/device's position with respect to the target.

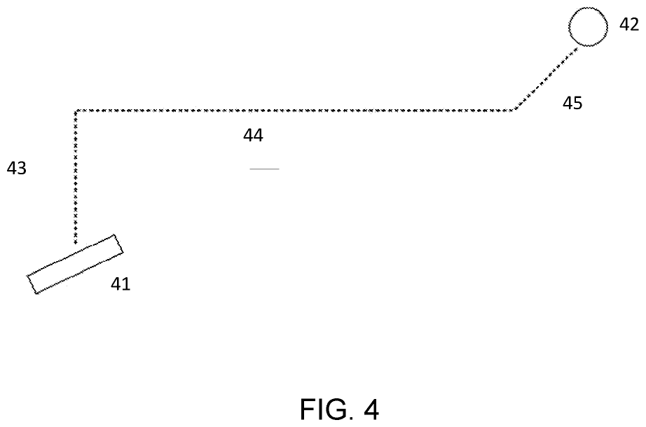

Referring now to FIG. 4 shows an embodiment with regards to the components of range.

Device 41 is targeting target 42 which is the Target object.

Looking at the X component 43 of the range to target object which also may be referred to as the North/South component. The feature is defined as parallel to the Prime Meridian and lines of latitude. The Y component 44 of the range to target object also referred to as East/West component is defined as parallel to the Equator and line of longitude. The Z component 45 of the range to target also referenced as height or altitude component is defined as perpendicular to both X and Y components and generally running along a line from the target object to the center of the Earth.

The coordinates once calculated, 43 (X), 44 (Y) and 45 (Z), are communicated via the network to the device 41 and fed into the firing display for the shooter to use to shoot the target 42. The solution is calculated and fed into the firing display for the shooter to use. The coordinates returned are based on the weapon's/device's position with respect to the target.

As noted, earlier atmospheric conditions are external variables that affect the flight path of a bullet and must be compensated for in order to achieve the most accurate ballistic intercept solution. The computer program of the device of collects these atmospheric conditions and applies them to the coordinate calculations to arrive at a target position. If requested by the user, the computer program will provide up to 6 alternative coordinate solutions for a target to account for miscalculations and sensor data irregulates. This provides the user with over, under, and exact calculated location solutions for the target.

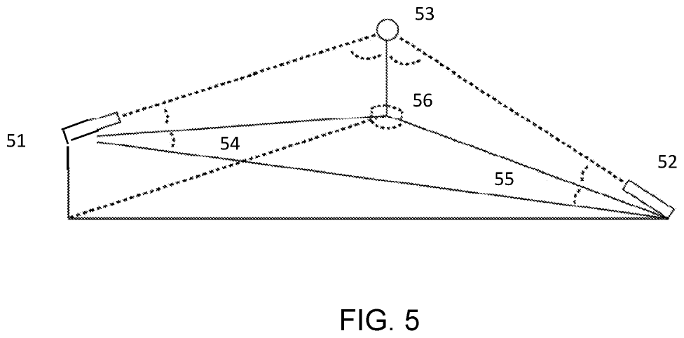

Referring now to FIG. 5 which shows an embodiment of the invention that is used for intersection targeting using two devices. Device 51 and device 52 are targeting target 53 and an embodiment calculates the coordinates for each device similar to the calculations done in FIG. 4, and communicates unique coordinates 43 (X), 44 (Y) and 45 (Z), and angles 54 and 55 via the network to the device 51 and device 52, and these coordinates and angles are fed into the firing display for the shooters of Devices 51 and 52 to use to shoot the target 42. The solution is calculated and fed into the firing display for the shooter to use. The coordinates returned are based on the weapon's/device's position with respect to the target and the orientation, location, range to target, and rate of change of the data to accurately locate the target in space and determine its velocity relative to the earth and position of the weapon/device.

An The device of the invention will continuously calculate the target position using target 42 position and trajectory, as well as the differences in time between each location. Using this data, the device 51 and 52 can calculate a speed and direction of movement (velocity) of the target.

Once the device 51 and 52 have determined the location either or both devices in absolutely and relative positions, as well as the velocity, if any, of the target 53, the devices 51 and 52 can transmit that data to other devices or other systems on the network. Alternatively, for a target 53 that is marked only once for targeting, that data can be used by the originating device 51 or device 52 as the coordinates and fed into the firing display for the shooter to use to shoot the target 53. The solution is calculated and fed into the firing display for the shooter to use. The coordinates returned are based on the weapons/device position with respect to the target.

As illustrated in FIG. 5, the target velocity and direction can also be integrated into calculations to determine the firing target location of a moving target and the anticipated target position associated with the firing time or the time that the user shoots at the target position 53. This is a replacement for traditional leading of the target to compensate for movement of a moving target. The device utilizes the orientation, location, range to target, and rate of change of the data to accurately locate the target in space and determine its velocity relative to the earth. As noted earlier, if requested by the user the computer program will provide up to 6 alternative coordinate solutions for a target to account for miscalculations and sensor data irregulates. This provides the user with over, under and exact calculated location solutions for the target.

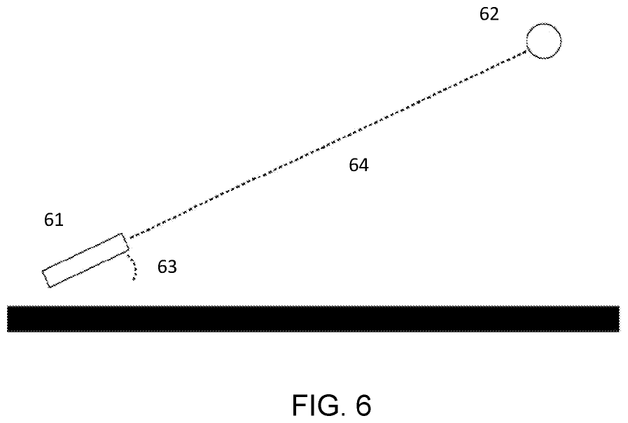

Referring now to FIG. 6, which shows a device designed for single device targeting, we have device 61, target object 62, angle of device 63, and measured distance to the target object 64.

If the operator using device 61 triggers the device 61 to track a moving target 62, the device 61 will continuously calculate the target 62 position using the methodology of FIG. 4, as well as the differences in time between each location of target 62. Using this data, the device can calculate a speed and direction of movement (velocity) of the target 62. The device utilizes the orientation, location, range to target, and rate of change of the data to accurately locate the target in space and determine its velocity relative to the earth.

Once the device has determined the location either or both absolutely and relatively, as well as the velocity, if any, of the target 62, the device 61 can transmit that data to other devices or other systems on the network. Alternatively, for target 62 that is marked only once, the data can be used by the originating device and the coordinates and can be fed into the firing display of device 61 for the shooter to use to shoot the target 62. The coordinates returned are based on the weapons/device position with respect to the target.

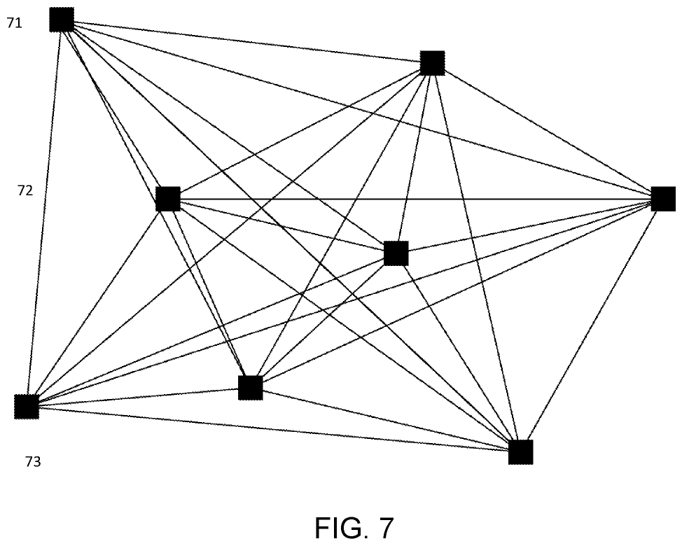

Referring now to FIG. 7, which shows an embodiment using a mesh network for the communication system mapping the data connections between devices. Target data would be sent along these connections. The squares are the devices and devices 71 and 73 are typical devices on the mesh network of an of and embodiment of the invention. Line 72 shows the connection between devices 71 and 73.

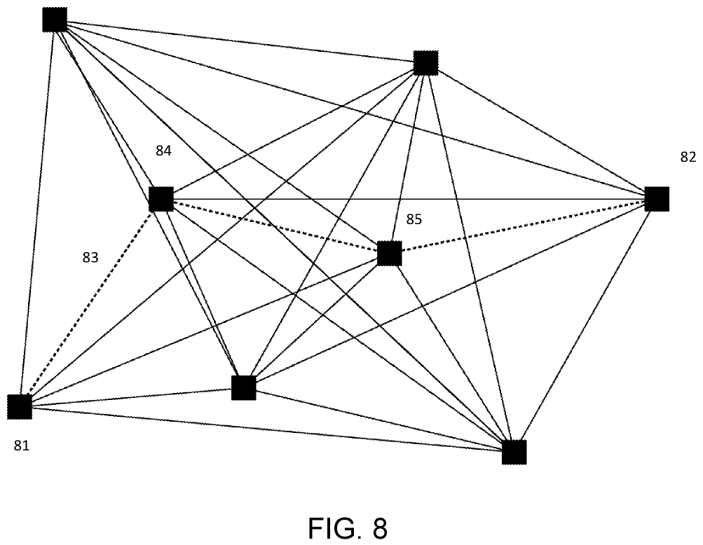

Referring now to FIG. 8 which shows an embodiment using a mesh network with non-direct connection when a direct connection is not available. Device 81 and device 82 are typical devices on the mesh network. The data flow through other devices by way of repeaters, with no direct connection, is shown by dotted line 83, and it relays information through devices 84 and 85 to feed information to device 82.

The device also communicates with other aspects of the invention such as the base station. The base station serves as a node for information into and out of the network from external sources. The base station creates and broadcasts Real Time Correction Measures (RTCM) data, as well as other targeting data, atmospheric data, software updates, and others. The device is capable of sending any data to an external source through the base station. The base station rebroadcasts this data via either wired or wireless connections to other types of systems in use by the user, such as military computers, storage networks, or radio systems. The base station is also capable of modifying data both coming in and leaving in order to properly communicate to the device or external systems.

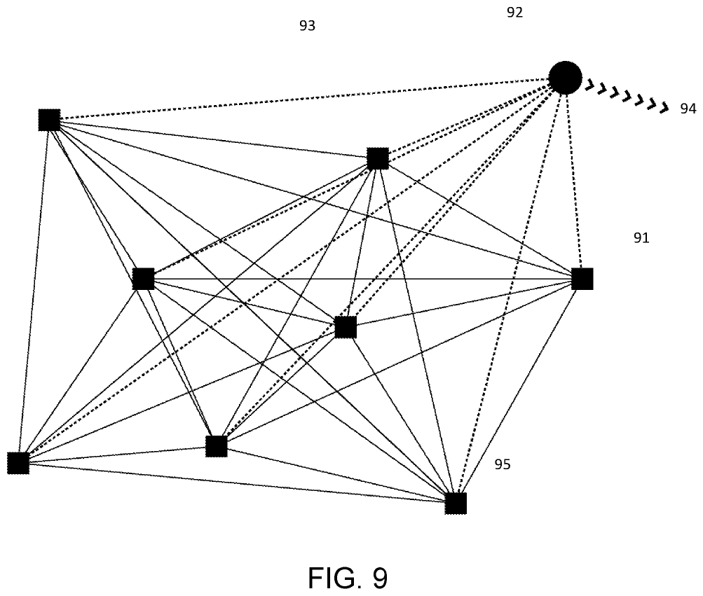

Referring now to FIG. 9 which shows an embodiment using a mesh network with a connection to an external system. FIG. 9 shows the Mesh networked devices 91 and 95 which are typical devices used by the embodiment, Base station device 92, Connections between base station and mesh networked device 93 and Connection to external systems 94. The network can communicate with more than one external system.

Devices of the invention can connect to one or more base stations at any time. Base stations can communicate with multiple mesh networks at any given time.

The base station can be a separate device or built into other network devices of the mesh networked such as devices 91 and 95.

The base station can also be connected with users or placed remotely using the external connection 94.

The device of the embodiment can utilize targeting data provided by external systems, as long as the data includes target location at a minimum.

The device of the invention uses the targeting data, as well as the device's location and velocity data, atmospherics, and weapon specific data to determine where the attached weapon needs to point in order to have effects on the target.

The system of the invention computes the flight time, drop due to gravity, and side motion of the bullets. This information is then used by the device to determine how the weapon should point so that the bullet when fired will hit the target. The information can be provided to the originating device or provided over the network for use by other connected devices.

Once the device of the invention computes the needed values (orientation) for hitting the target, it compares the present orientation to the needed. This difference is how the operator must move the weapon. The device displays this difference graphically on a screen or other interface for use by the shooter to shoot the target.

The device of the invention will show the shooter when they are getting closer and on target, and will also give users the command to fire as well as other commands.

The system may also compute multiple points of aim to hit a target that is moving, or from a moving device, or both.

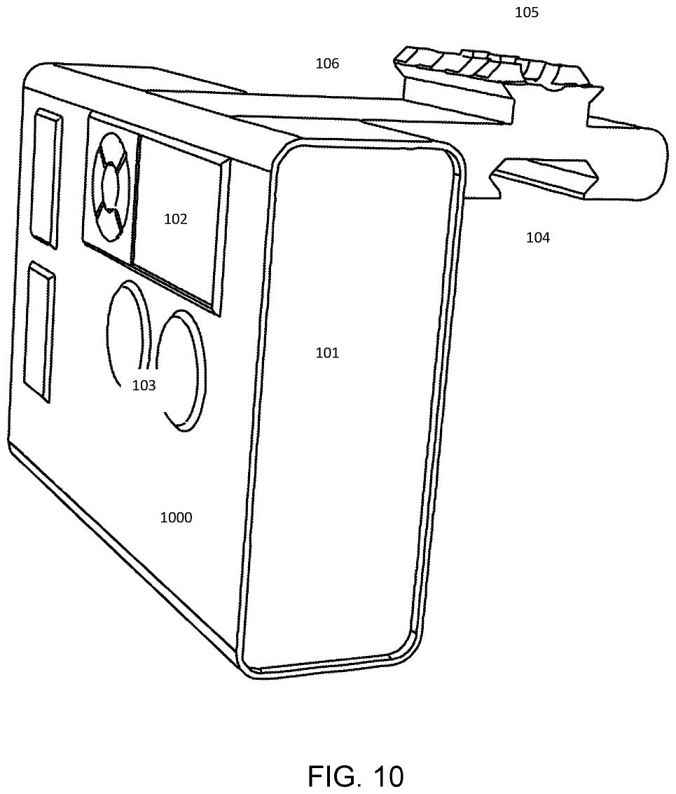

Referring now to FIG. 10 which shows the device 1000 which is one embodiment of the invention and schematically showing major components (rear quarter, facing user). The primary user interface 101 used primarily for targeting. Item 102 is the secondary user interface used for device setup, Item 103 is the control button used by the user to interface with primary user interface 101 and secondary user interface 102 for inputting information into the device 1000.

Item 104 is the common mounting rail for mounting device to weapon and item 105 is a common mounting rail for mounting accessories. Item 106 is a detachable mounting rail component.

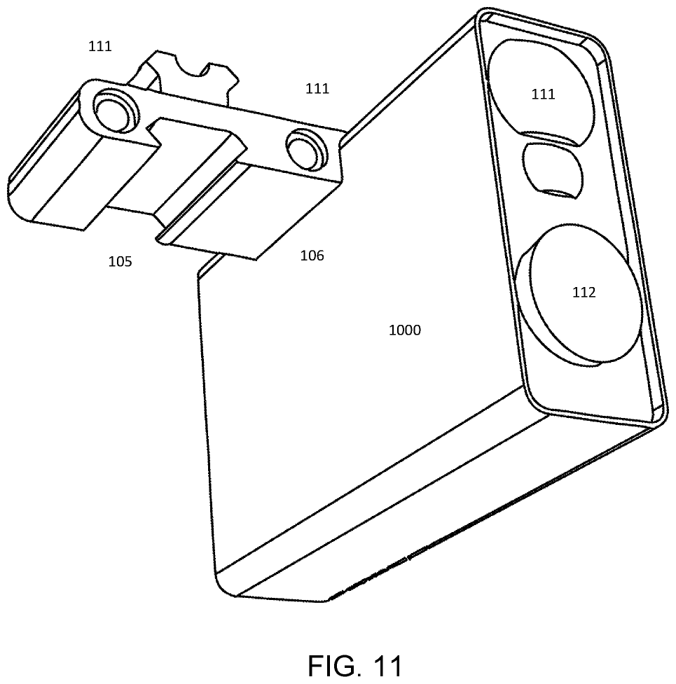

Referring now to FIG. 11 which shows the device 1000 which is one embodiment of the invention and schematically showing the front quarter (facing towards target). The Sensors and cameras are shown as item 111, the power and battery lid cover item 112, the common mounting rail item 105 and the detachable mounting rail component item 106.

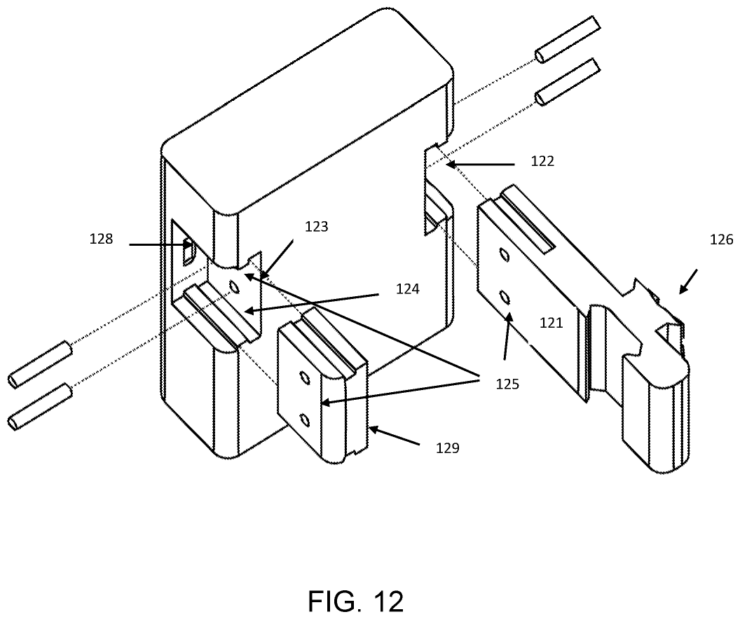

Referring now to FIG. 12 the device is generally designed to mount to a Picatinny or similar rail system, common on military and other firearms. Due to the device design and use, the standard mounting may not always be the most useful. Certain weapons systems are of different shapes, have rails in locations that aren't useful, lack rails at all or are otherwise not capable of mounting the device in the standard configuration.

The device is designed such that the mounting bracket 121 is able to be removed from its mounting location 122 and moved to another mounting location 123 such as on the bottom of the device. This would change how the device sits relative to a weapon.

The mounting bracket 121 can alternately be switched for another mounting bracket, such as one designed to mate to non-Picatinny rail systems, or for specific weapons systems requiring a unique mount such as a mortar. The mounting rails all have common components where the bracket meets the device such as mounting rails 124 and/or holes for screws 125. These ensure a secure connection between the device and any mounting bracket, as well as easy interoperability for the user.

The mounting bracket 121 can, in addition to mounting the device to a weapon, serve other purposes. The bracket can include additional mounting rails 126 for optics or other systems. In addition, the mounting bracket may contain sensors utilized by the device such as cameras, electromechanical sensors, antennas, radios or others.

The mounting bracket 121 is secured to the device with a combination of the mounting rails 124 and screws 126 or similar user removable parts.

The mounting bracket 121 fits into a cavity in the device 122 & 123. This strengthens the mount and protects a wiring connection 128 between the device and the mounting bracket 121. The wiring connection can supply or receive power and information between the device and the mounting bracket 121

When not used for the mounting bracket 121, any cavities may be filled with a plug 129. This plug keeps the connections clear from dirt and dust. The plug may also contain batteries, sensors, or other electronic components which aid in the device's functioning. The plug 129 could also be used to enhance the features of the device, for instance having a wired connection to an external power supply or data supply.

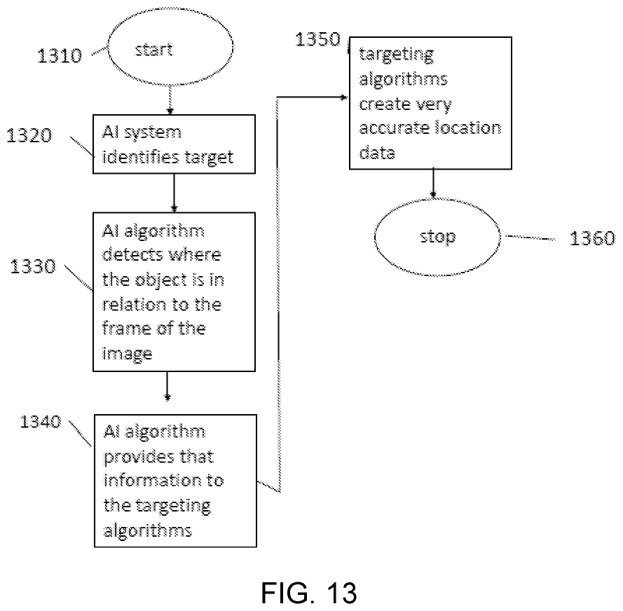

Referring to FIG. 13 which shows another preferred embodiment that utilizes AI algorithm of the instant invention to identify drones and stabilize the target location. The system uses the information to adjust the ballistic solution of a weapon and the weapon can be selected from the group of weapons consisting of M16, M4, M249, M240 and M2. The system uses a camera, LIDAR or similar detection device and acquires or takes an image of the target area. Alternative image devices include sonar device, radar device, CCD camera, infrared sensor device and LIDAR device. The system starts the AI algorithm step 1310.

The AI algorithm contained in the on-board computer processor is used to identify target objects in the image step 1320. These objects which are targeted by the system can be any object that the algorithm has been trained to identify. Therefore, the target can be an individual, vehicle, drone, communications balloon or parachute or any battlefield device.

The AI algorithm detects where the object is in relation to the frame of the image step 1330, which allows the system to calculate the relative location of object in relation to the system.

Once the relative location is known the AI algorithm provides that information to the targeting algorithms step 1340 to adjust or lock on the target and create very accurate location data file step 1350 which is needed to direct the fire at the object. The AI algorithm stops step 1360.

This helps to eliminate issues with targeting an object where the weapon is not always exactly pointed at the target (i.e., if the target is moving and the individual manning the weapon has trouble following it).

The instant invention using the AI algorithm can be used by a system receiving targets information. The instant invention using the AI algorithm can identify the target and ensure that the system is pointed in the right position. This helps to correct for errors which can occur in the positioning and orientation hardware and allows for targeting to be done under adverse conditions such as if the user position and orientation are experiencing degraded conditions such as when the system GPS is jammed, or you are indoors and not able to receive GPS information.

Additionally, the AI algorithm targeting data can be sent between two or more systems to help the users pick out the correct target. This is important where the target is in a group. For example, if there are two individuals next to each other, one wearing red and one wearing blue, and the blue individual is targeted, the receiving systems will show the user to engage the “blue individual.” This helps ensure the user has accurate target information before engaging but it also creates the ability pass accurate date and information along to other individuals and weapons.

Using the AI algorithm and statistical modeling the instant invention can “fill in the gaps” on when tracking a moving target and one or more readings are not aligned. The AI algorithm will fit the received data into a model and calculate the track or position of the target.

Furthermore, the instant invention system is designed to be able to track moving objects, but by the nature of warfare and the system, there can be times where data from certain sensors is not available or is showing incorrect data. The AI algorithm will fit the received data into a model and calculate the track or position of the target thereby providing predictive information to the user.

The system can use the AI algorithm to compensate and create the most likely target track even with one or more degraded sensors. This minimizes the time to remove the target from the battlefield and reduces the danger to all friendly combatants.

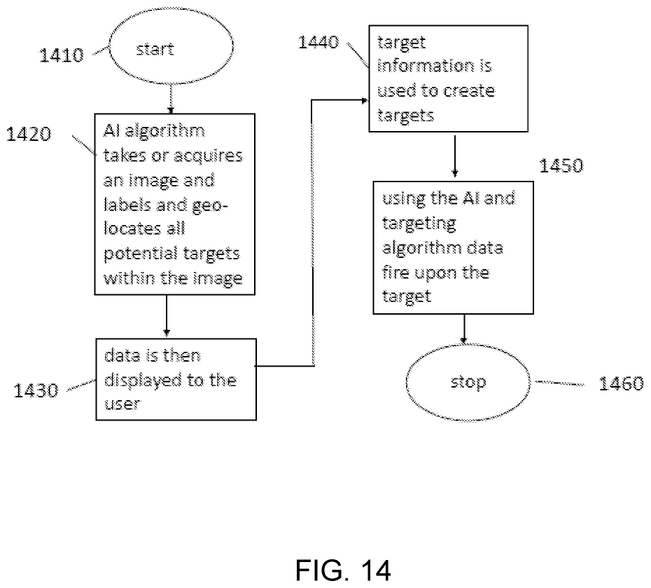

Referring to FIG. 14 which shows a second alternative embodiment utilizing Artificial Intelligence algorithm of the instant invention. Step 1410 is the start of this embodiment. The embodiment uses the AI algorithm to automatically identify potential targets and classify them. This is similar to the previously described AI system. Step 1420 The AI algorithm in this embodiment takes or acquires an image and labels and geo-locates all potential targets within the image.

In step 1430 the data is then displayed to the user which provides them with various target information. Step 1450 the target information is used to create targets which can be fired upon using the AI and targeting algorithm data Step 1460. An example is that the user can issue a command to the system to target all tanks that are in view, and the AI algorithm will create a target package finds all the tanks and provide target information. The instant invention can also send to other users or area commanders the information for intelligence and targeting purposes.

The instant invention can also utilize visual and/or lidar devices connected to the system as additional source of information for orientation and positioning of targets. This is particularly useful when the system GPS is degraded, jammed, or denied in the specific environment. Alternative image devices include sonar device, radar device, CCD camera, infrared sensor device and LIDAR device.

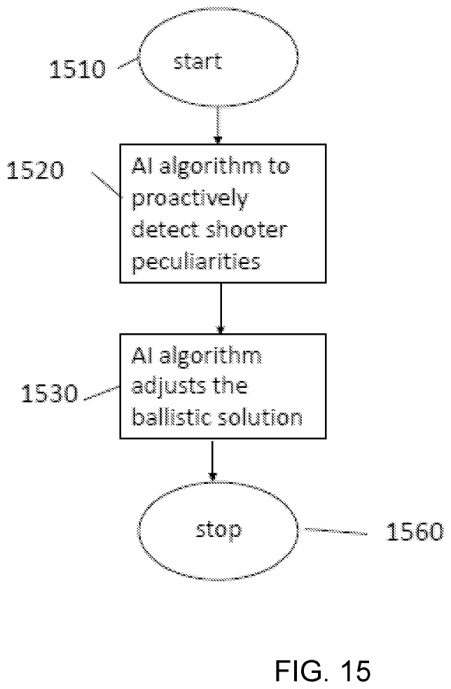

As shown in FIG. 15 the third preferred embodiment utilizing Artificial Intelligence algorithm of the instant invention is similar in concept to the second preferred embodiment except it uses the AI algorithm to understand the system's location and orientation, not the targets. Step 1510 is the start of this embodiment

The instant invention can use the AI algorithm to proactively detect shooter peculiarities step 1520 and adjust the ballistic solution to accommodate them step 1530. The Ai algorithm stops step 1560.

The AI can learn individual shooter needs and adjust accordingly.

### Examples

a. Shooter consistently pulls left. The AI algorithm can adjust the solution to compensate for it.
b. Shooter is slower or faster on trigger pull than standard. The AI algorithm can adjust the shots.
c. shooter peculiarities can also include trigger pull errors, erroneous trigger pull motions, pulling of the trigger with index finger's II phalanx instead of III phalanx, fast and jerky trigger pull and too fast release of the trigger.

The AI algorithm can also adjust for users based on differences in the environment and conditions such as hot weather or after a long run the shooter will be faster/slower than normal.

This system can find cause/effects which may not be obvious to a human observer and implement changes based off the issues identified. For example, the AI algorithm can adjust if a soldier is slower to shoot when its cloudy. We may not know why, but it can still be compensated for.

The instant invention can further be described as an alternative computer system for determining target coordinates of a target comprising:
a. an image acquisition device for acquiring an image;
b. a computer system and the computer system having a user interface, a targeting algorithm, an artificial intelligence algorithm and said computer in communication with a weapon;
c. a display in communication with said user interface;
d. the artificial intelligence algorithm capable of sending instructions to the targeting algorithm; and
e. the weapon in communication with the computer system and the weapon capable of receiving instructions from the targeting algorithm.

The method of using the alternative computer system wherein the on-board computer processor identifies a target using:
a. an image acquisition device and the image acquisition device acquiring an image and the image having an image frame;
b. the image acquisition device sending the image to the artificial intelligence algorithm;
c. the artificial intelligence algorithm detecting where the object is in relation to the frame of the image and the artificial intelligence algorithm calculating a relative location of the target;
d. the artificial intelligence algorithm transferring the image and the relative location of the target to the targeting algorithm and the targeting algorithm creating very accurate location data file of the target; and
e. the targeting algorithm transferring the very accurate location data file of the target to the computer system and the computer system transferring the very accurate location data file to the weapon.

The method of using the alternative computer system wherein the target is selected from the group comprising of an individual, vehicle, drone, communications balloon, a parachute antenna and a battlefield device.

The method of using the alternative computer system wherein said image acquisition device is selected from the group consisting of sonar device, radar device, CCD camera, infrared sensor device and LIDAR device,

The method using the alternative computer system wherein the weapon is selected from the group of weapons consisting of M16, M4, M249, M240 and M2.

The method of using the alternative computer system wherein the on-board computer processor identifies a target by executing the following steps:
a. acquiring an image using the image acquisition device and the image having an image frame;
b. the image acquisition device sending the image to the artificial intelligence algorithm;
c. the artificial intelligence algorithm labeling and geo-locating all potential targets within the image and creating a target information file for all potential targets.
d. the artificial intelligence algorithm creating a target package for all targets; and
e. the artificial intelligence algorithm transferring the target information file to the computer system and the computer system displaying the target information file using the user interface.

The method of using the alternative computer system wherein the target is selected from the group comprising of an individual, vehicle, drone, communications balloon, a parachute antenna and a battlefield device.

The method of using the alternative computer system wherein the on-board computer processor identifies the computer system's location and orientation using the following steps:
a. the artificial intelligence algorithm detecting shooter peculiarities;
b. the artificial intelligence algorithm analyzing the shooter peculiarities and transfers the shooter peculiarities to the targeting algorithm; and
c. the targeting algorithm adjust the ballistic solution to accommodate the shooter peculiarities.

The method of using the alternative computer system wherein the shooter peculiarities is selected from the group comprising of trigger pull errors, erroneous trigger pull motions, pulling of the trigger with index finger's II phalanx instead of III phalanx, fast and jerky trigger pull and too fast release of the trigger.

In some embodiments the method or methods described above may be executed or carried out by a computing system including a tangible computer-readable storage medium, also described herein as a storage machine, that holds machine-readable instructions executable by a logic machine (i.e. a processor or programmable control device) to provide, implement, perform, and/or enact the above described methods, processes and/or tasks. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI) or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard or gaming controller. For example, a user input may indicate a request that certain task is to be executed by the computing system, such as requesting the computing system to display any of the above described information, or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim. It is intended that broader claims will be submitted in an application that claims the benefit of priority from this application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A computer system for determining target coordinates of a target comprising:
a. an image acquisition device for acquiring an image;
b. a computer system and said computer system having a user interface, a targeting algorithm and an artificial intelligence algorithm;
c. a display in communication with said user interface;
d. a wireless communication device;
e. said artificial intelligence algorithm capable of sending instructions to said targeting algorithm; and
f. a weapon in communication with said computer system and said weapon capable of receiving instructions from said targeting algorithm.

2. The method of claim 1 wherein said weapon is selected from the group of weapons consisting of M16, M4, M249, M240 and M2.

3. The method of claim 1 wherein said image acquisition device is selected from the group consisting of sonar device, radar device, CCD camera, infrared sensor device and LIDAR device,

4. The method of using the computer system of claim 1 wherein said on-board computer processor identifies a target comprising the following steps:
a. acquiring an image using said image acquisition device and said image having an image frame;
b. said image acquisition device sending said image to said artificial intelligence algorithm;
c. said artificial intelligence algorithm detecting where the object is in relation to the frame of said image and said artificial intelligence algorithm calculating a relative location of said target;
d. said artificial intelligence algorithm transferring said image and said relative location of said target to said targeting algorithm and said targeting algorithm creating very accurate location data file of said target; and
e. said targeting algorithm transferring said very accurate location data file of said target to said computer system and said computer system transferring said very accurate location data file to said weapon.

5. The method of claim 2 wherein said target is selected from the group comprising of an individual, vehicle, drone, communications balloon, a parachute antenna and a battlefield device.

6. The method of using the computer system of claim 1 wherein said on-board computer processor identifies a target comprising the following steps:
a. acquiring an image using said image acquisition device and said image having an image frame;
b. said image acquisition device sending said image to said AI algorithm;
c. said artificial intelligence algorithm labeling and geo-locating all potential targets within said image and creating a target information file for all potential targets.
d. said artificial intelligence algorithm creating a target package for all targets; and
e. said artificial intelligence algorithm transferring said target information file to said computer system and said computer system displaying said target information file using said user interface.

7. The method of claim 6 wherein said target is selected from the group comprising of an individual, vehicle, drone, communications balloon, a parachute antenna and a battlefield device.

8. The method of using the computer system of claim 1 wherein said on-board computer processor identifies said computer system's location and orientation comprising the following steps:
a. said artificial intelligence algorithm detecting shooter peculiarities;
b. said artificial intelligence algorithm analyzing said shooter peculiarities and transfers said shooter peculiarities to said targeting algorithm; and
c. said targeting algorithm adjust the ballistic solution to accommodate said shooter peculiarities.

9. The method of claim 8 wherein said shooter peculiarities is selected from the group comprising of trigger pull errors, erroneous trigger pull motions, pulling of the trigger with index finger's II phalanx instead of Ill phalanx, fast and jerky trigger pull and too fast release of the trigger.
